(19) United States
(12) Patent Application Publication
(10) Pub. No.: US 2003/0191677 A1
(43) Pub. Date: Oct. 9, 2003

(54) Method and system for integrating e-Logistics processes into a user/provider interface using Web Services

(76) Inventors: Rama K. Akkiraju, Yorktown Heights, NY (US); Henry Chang, Scarsdale, NY (US); Tian-Jy Chao, Bedford, NY (US); Jen-Yao Chung, Yorktown Heights, NY (US); David B. Flaxer, Accord, NY (US); Jun-Jang Jeng, White Plains, NY (US); Liang-Jie Zhang, Cortlandt Manor, NY (US)

Correspondence Address: Whitham, Curtis & Christofferson, PC, Suite 340, 11491 Sunset Hills Road, Reston, VA, 20190, US

(21) Appl. No.: 10/106,186

(22) Filed: Mar. 27, 2002

(51) Int. Cl. G06F 17/60

(52) U.S. Cl. 705/8; 705/1

(57) ABSTRACT

A system and method for providing specified electronic commerce services to users, in particular e-Logistics services, services which are available in the marketplace from a variety of service providers whose electronic commerce systems are incompatible. There is provided a user/customer interface to the specified electronic commerce services, called a Common Alliance Interface, and a distinct interface for service providers of the specified electronic commerce services. Between the two interfaces is a business process layer which integrates one or more components of the specified electronic commerce services, these integrated components thereby being transparent to users. The service provider obtains access to users of the Common Alliance Interface by updating entries in a UDDI registry. There is further provided a service template which the service provider can modify to provide an adaptation layer between their legacy application and the business process layer. There is disclosed a business process layer of e-Logistics services comprised of RFQ, shipping and tracking processes.

### BACKGROUND OF THE INVENTION

1. Field of the Invention

The present invention generally relates to business processes implemented through electronic commerce services, and more particularly to methods for integrating diverse and incompatible electronic commerce systems, such as those that provide for the physical shipment of goods.

2. Background Description

In the last couple of years, various on-line shipping tools have been developed for e-Commerce application developers. For example, in the transportation industry, United Parcel Service (UPS) provides on-line XML Tools and HTML Tools (see UPS On-line E-Commerce Tools, http://www.ec.ups.com), and FedEx provides their own Web tools (FedEx API; see http://www.fedex.com) for their developers to enable the development of on-line shipping tools. However, there appears to be no common service interface to allow users/customers (e.g. of shipping services) to easily integrate existing tools. User/customer application developers have to manually construct different requests for different backend servers, and this manual construction demands much effort and time. Different shipping service providers might require different implementations and could have proprietary platform and their own implementation constraints.

In order to expedite the shipping process and minimize costs, shipping solutions must empower the customers and suppliers with the ability to rate, ship and track shipments. While many solutions in today's competitive market achieve this, they are deficient in one or more particulars. For example, there are platform dependent solutions unique to a specific shipping service provider. These solutions are not generic and could not be considered as a standard to be followed by the rest of players in the industry. Other solutions are windows-based applications that are mostly available to users for purchase as stand-alone applications. See Shipping Automation: Clippership, available from Kewill, http://www.kewill.com.

With the development of Web Services, defining uniform interfaces for the solution developers becomes technically feasible, which leads to potential business opportunities. Further, integrating Web Services and common proprietary interfaces allows shipping services to adhere to a model that could be considered a generic shipping service. This is critical because this allows a shipping service client (such as an e-Commerce application) to design and deploy code using a generic shipping model covering multiple transportation service providers. At run time the application uses a dynamic data binding mechanism to invoke a specific implementation of a shipping service and receive results back. Because Web Services can be implemented in any programming language, developers are not obligated to change their development environments in order to generate or use Web Services. Consequently, any client application can benefit from architectural independence that is embraced in this framework.

For most integration architectures—and Web Services are no different—Extensible Markup Language (XML), a subset of Standard Generalized Markup Language (SGML) promulgated by the International Standards Organization (ISO), plays a role in simplifying the exchange of business data among companies by providing a cross-platform approach in the areas of data encoding and data formatting. For example, Simple Object Access Protocol (SOAP), which is built on XML, defines a simple way to support Web Services by packaging information for exchange across system boundaries. Universal Description and Discovery Integration (UDDI) Registries, which describe Web Services and how to invoke them, support programmable XML elements to be placed in the Registries where others can access them remotely.

Electronic commerce requires the integration of a wide range of trading partners and service providers orchestrated to complete a business transaction. Service providers include those in the logistics industry—companies that specialize in transporting goods between buyers, sellers and intermediaries. In recent years, many transport companies have enabled proprietary programming interfaces to their service applications, and on-line shipping tools for supporting such functions as request for quotes, order placement and shipping status. Since the interface for each transport company is unique, this forces developers of e-Commerce applications to implement individual support for each company. As a result, the need to support multiple interfaces not only increases code complexity and cost but also makes the applications hard to maintain.

Web Services have been introduced to address some of the problems that are inherent in the establishment of common application interfaces supporting business processes, trading partners and service providers. Web Services are a set of open standards that facilitate program-to-program interaction by specifying a programmatic means to describe, publish, discover and bind application interfaces. Web Services enables common means for discovery and invocation of services, such as those offered by transport companies.

However, because of the lack of industry-specific standards, service providers publish web service's that provide the same functions with different invocation parameters and method signatures. Once again, e-Commerce application developers are faced with the need to implement invocation mechanisms to support each service provider's unique methods. Moreover, while Web Service interfaces for new and legacy services are rapidly becoming adopted, there is no guarantee that an agreed-upon standard will be implemented by all companies in an e-Commerce industry, and in particular e-Logistics.

### SUMMARY OF THE INVENTION

It is therefore an object of the present invention to provide a methodology to support efficient and effective interoperability between business customers and e-Logistics (transportation and shipping) service providers.

Another object of the invention is to provide an intermediary and independent process that can interact with all types of services, including Web Services and proprietary interfaces, supported by companies within the logistics industry.

Yet another object of the invention is to provide an alternative to industry standardization, which overcomes the burden upon user applications caused by a plurality of invocation parameters and method signatures for Web Services published by different service providers.

It is also an object of the invention to allow an e-Commerce user application to request a service with a single invocation to an interface, with interactions with multiple service providers being handled transparently via a common framework, thereby avoiding high cost and complexity.

A further object of the invention is to provide a framework that can be adopted to support industries that fail to secure commonly adopted service and interface standards.

An object of the invention is to provide a multi-platform approach that provides better offerings and solutions that can assist any industry to accomplish their transactions efficiently and profitably.

Yet another object of the invention is to insure that any e-Commerce application can efficiently find and invoke multiple transportation services through a single interface.

It is also an object of the invention to provide a methodology for automating business process integration which will result in reduced integration time and cost and increased efficiency of service delivery, so as to gain competitive advantage in the marketplace.

To address these objectives, this invention describes a new and innovative framework, based on a Web Services Model. See http://www-3.ibm.com/software/solutions/webservices/ for more information about what Web Services are how they are applied to support electronic commerce. The invention is an apparatus and method of efficiently integrating business processes into an electronic commerce interface using Web Services. As an integral part of the invention, a Service Template is provided to serve as a model for service providers to adapt their legacy or proprietary systems to the invention's interface.

One embodiment of the invention is a method for providing specified electronic commerce services to users, services that are available in the marketplace from a variety of service providers whose electronic commerce systems are incompatible. Consequently, users are provided a “lens” through which they can “see”—and have access to—the marketplace as whole, with all its service providers. The method comprises several steps. The first step is to develop a user interface to the specified electronic commerce services. In this invention, this user interface is called a Common Alliance Interface. The next step is to develop an interface for providers of the specified electronic commerce services, which we will call a Webservice Interface. Each service provider must develop an application, called an Adaptation Layer, to connect their own legacy system to this interface. An aspect of the invention is to provide a Service Template that the service provider can modify to construct the Adaptation Layer. Finally, there is the step of integrating one or more components of the specified electronic commerce services into a Business Process Layer. This layer is accessed asymmetrically, from one side by users through the Common Alliance Interface and from the other side by the service providers through the Webservice Interface. Thus, the Business Process Layer is sandwiched between the user interface and the service provider interface. The service providers specify how their business processes are to be invoked, and this specification is incorporated into a registry of all available service provider business processes. The implementation of this specification is contained in the Adaptation Layer. The registry is logically within the Business Process Layer, although it may be physically located elsewhere than the servers handling the Business Process Layer.

In a further embodiment, the invention is an asymmetric electronic commerce interface comprising a first interface being a Common Alliance Interface for users of specified electronic commerce services; a second interface for providers of the specified electronic commerce services (and also including a Service Template that can be used by service providers to construct an Adaptation Layer for that interface); and a Business Process Layer integrating to this interface. An aspect of the invention is to provide a Service Template that the service provider can modify to construct the Adaptation Layer. Finally, there is the step of integrating one or more components of the specified electronic commerce one or more components of the specified electronic commerce services and being sandwiched between said first and second interfaces. Each of the service providers maintains access to users by updating entries for the service provider in a registry of the specified electronic services and by modifying the Service Template to be an Adaptation Layer between a legacy application of the service provider and the Business Process Layer. The registry is dynamic, that is, service providers are able to add and revise their entries at any time. Furthermore, the Adaptation Layer provides dynamic binding of data from the legacy application to the Business Process Layer.

The exemplar implementation of the invention described herein is with respect to logistics industry processes in electronic commerce (henceforth called E-Logistics), thereby providing an E-Logistics Process Integration Framework (ELPIF). In the preferred embodiment the implementation uses Web Services. ELPIF allows shipping service providers to map their existing applications into a framework that supports a common Web Service invocation interface. By enabling a standard Web Service interface via the framework, participating shipping service providers can make optimum use of their legacy applications and run efficiently with minimal cost input.

ELPIF exploits Web Services as the building blocks, further distinguishing it from existing integration solutions, most of which are either standalone applications or hard-wired with specific platforms. Hence, ELPIF contributes to business process integration by providing a new service delivery model via a design pattern and service templates, for the shipping industry in particular, and all industries that demand a general solution to business integration.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A is an interaction diagram showing a high level view of an e-logistics process integration framework (ELPIF). FIG. 1B shows a customer application under the prior art invoking a plurality of service providers without the aid of a service methodology. FIG. 1C shows a customer application under the prior art using a third party to invoke a plurality of service providers.

FIG. 2 is a schematic diagram showing an architecture for integration of business processes within an electronic commerce domain.

FIG. 3 is a business process integration diagram for purchase order fulfillment in the e-Logistics domain.

FIG. 4 shows an integration architecture for a service provider Adaptation Layer mapping of requests and responses.

FIG. 5 shows a working Business-to-Business (B2B) system using the invention in the e-Logistics domain.

FIG. 6 illustrates detail from a purchase order database implementing the invention as applied to e-Logistics services. FIG. 6A is a table showing a purchase order at the beginning of processing. FIG. 6B is a table showing transporter look up, quotes and selection. FIG. 6C is a table showing the purchase order after a transporter is selected, which completes the purchase order processing.

### DETAILED DESCRIPTION OF A PREFERRED EMBODIMENT OF THE INVENTION

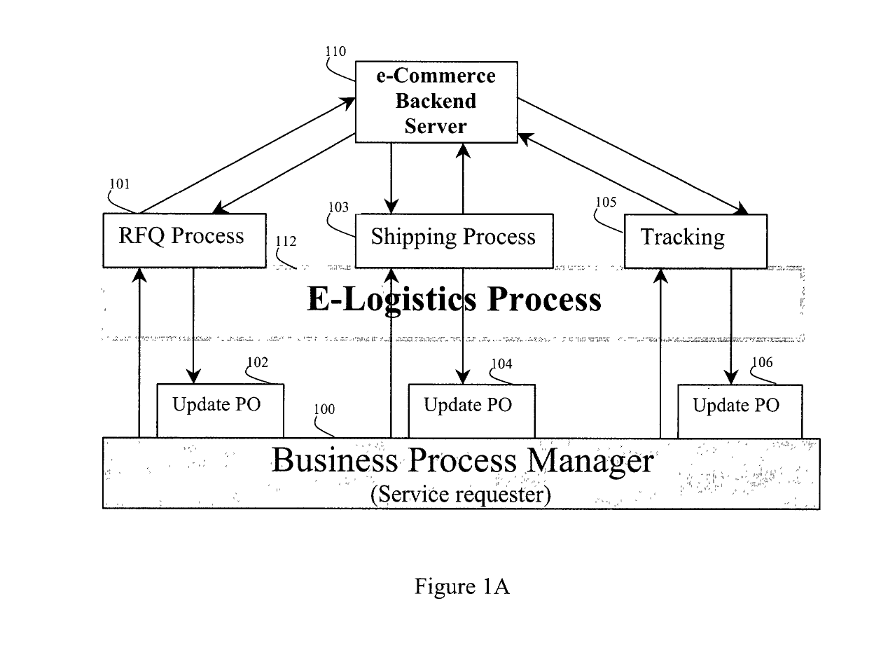

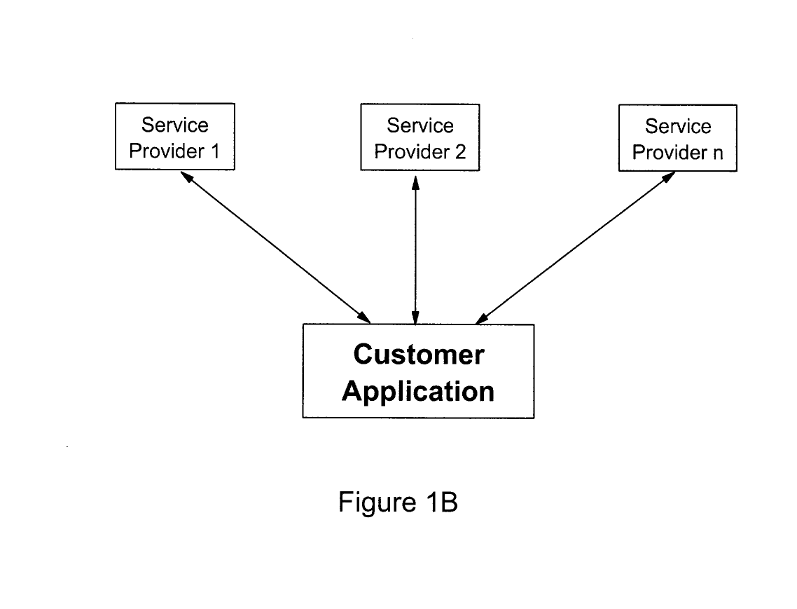

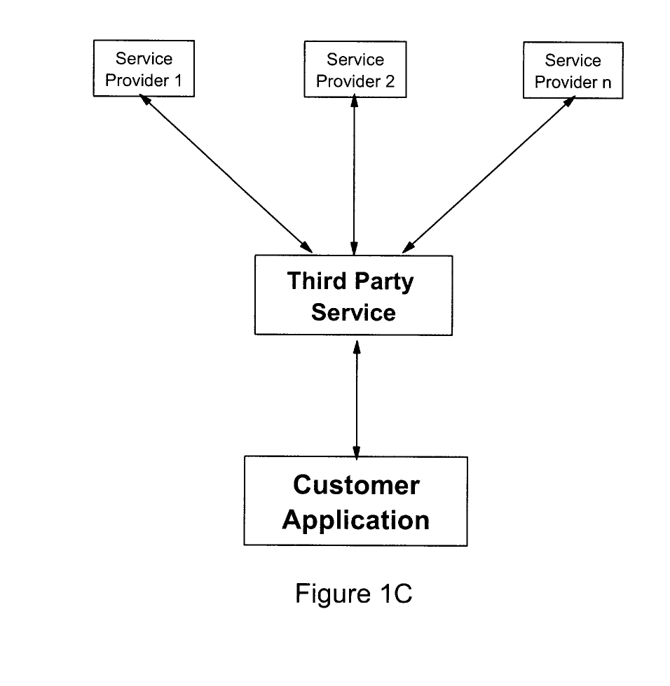

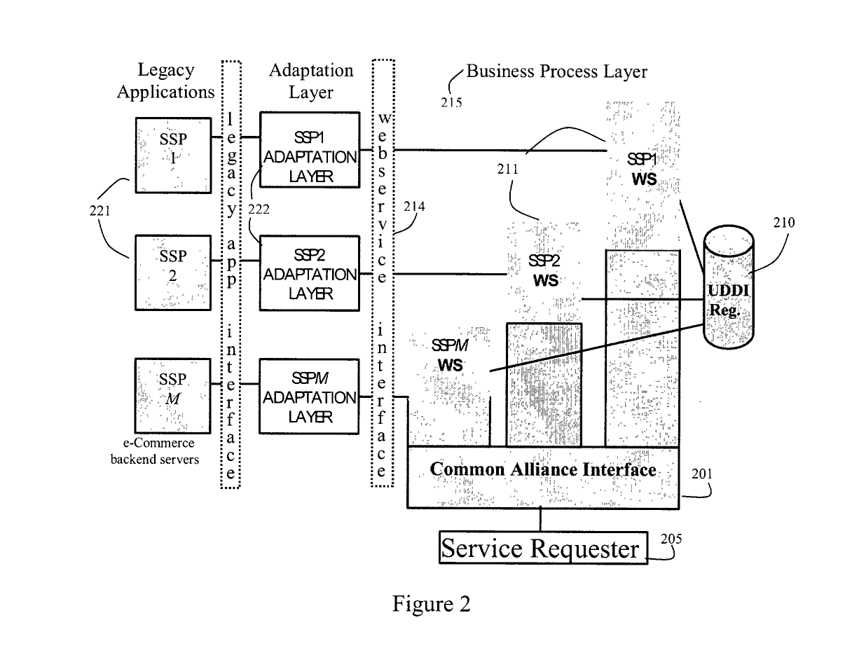

Referring now to the drawings, and more particularly to FIG. 1, there is shown an interaction diagram giving a high level view of ELPIF. The typical e-Logistics processes include Request For Quotes (RFQ) 101, Shipping 103, and Tracking 105. As shown in FIG. 1, these e-Logistics processes interact with the Business Process Manager 100, which requests services from an e-Commerce back-end server 110 (e.g. a UPS server, a FedEx server, or an Airborne server). The business process manager 100 invokes the RFQ process 101 to get the basic services such as getting the quotes in an e-logistics process. Whenever a response is obtained from the RFQ business process a purchase order (PO) is updated 102. Shipping process 103 is also invoked by the business process manager 100 and upon completion updates the PO (at 104). Once goods are shipped, the tracking process 105 is invoked and a tracking number is given to the customer and that tracking number is mapped to the PO number (at 106) in an e-commerce system. Customers can track their shipment with the help of that number. In the present invention, these business processes are integrated (as shown by e-Logistics Processes 112) via a Business Process Layer (further described in connection with FIG. 2) so that the differences between back-end servers 110 are transparent to business process manager 100.

To enable the ELPIF framework the present invention introduces a common interface behind which is an independent service that implements the concepts of Common Alliance Interface, Adaptation Layer and Dynamic Data Binding mechanism. These elements may be better understood by reference to FIG. 2. Shipping service providers having legacy applications 221 enter the ELPIF framework via Adaptation Layer 222. Users/customers request shipping services via Common Alliance Interface 201. While each shipping service provider is responsible for its own Adaptation Layer 222, the present invention provides a Service Template which can be adapted by a shipping service provider to generate its own Adaptation Layer 222. In addition to the Adaptation Layer, a shipping server provider is also responsible for publishing a specification of its business processes into a common specification registry, as described below.

In a preferred embodiment of EPLIF, the Common Alliance Interface 201 is implemented as a Web Service, following all the protocols of a Web Service, including implementing the common specification registry as a UDDI registry. Common Alliance Interface 201 is a higher-level service interface layer that shields the Business Process Manager 100, or Service Requestor 205, from multiple shipping service providers 211 (Shipping Service Provider 1 [SSP1] with its own Web Services [WS], Shipping Service Provider 2 with its own Web Services, etc. . . . including Shipping Service Provider M with its own Web Services) and provides an abstraction layer of all available services. This interface contains the method signatures required to invoke the functions that each service provider is including in its own Web Services 211. The functions themselves are implemented by the service provider, in accordance with the specification published by the service provider in the UDDI Registry 210.

For the ELPIF implementation of the invention, the Web Services 211 include the business processes shown in FIG. 1A (RFQ Process 101, Shipping Process 103 and Tracking Process 105). For each of the business processes included in the Common Alliance Interface 201, any shipping service provider (SSP) participating in the marketplace established by the framework must publish into a specification registry (e.g. UDDI Registry 210) a specification which defines the method signatures needed to invoke the SSP's business process. The standardized format of the specification registry enables integration of the specified business processes into the Common Alliance Interface 201.

Consequently, the framework of the invention has two different sets of requirements, one for users/customers and a second for shipping service providers. These different sets of requirements define two different interfaces for the invention. Users request services through a first interface at the Common Alliance Interface 201, which tells the developers of user/customer applications (e.g. Business Process Manager 100) how to request a specified service. Behind the user interface—and transparent to the user—is a Business Process Layer (e.g. the Web Services Layer shown in FIG. 2) which uses the structure and the content of the specification registry to transform user requests for specified services so as to be received at the service provider interface by each shipping service provider who has published a corresponding specification in the specification registry.

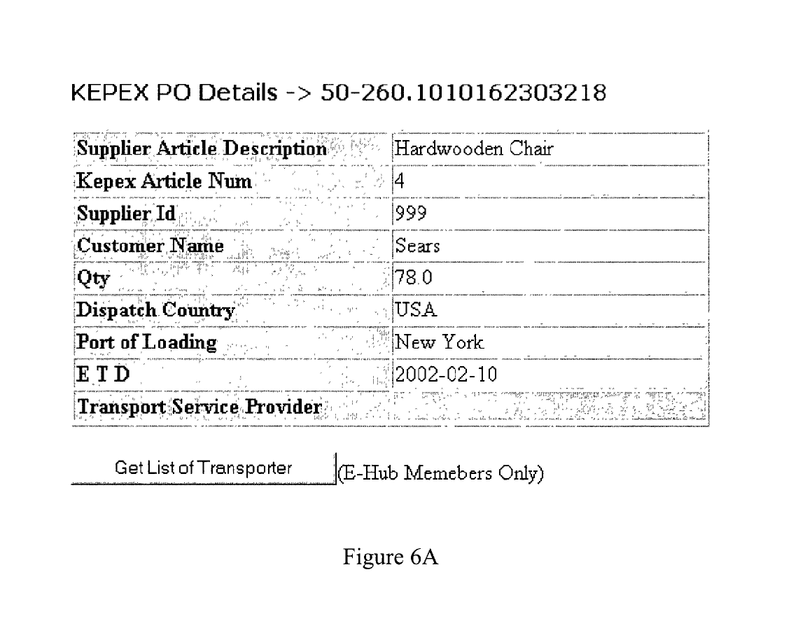

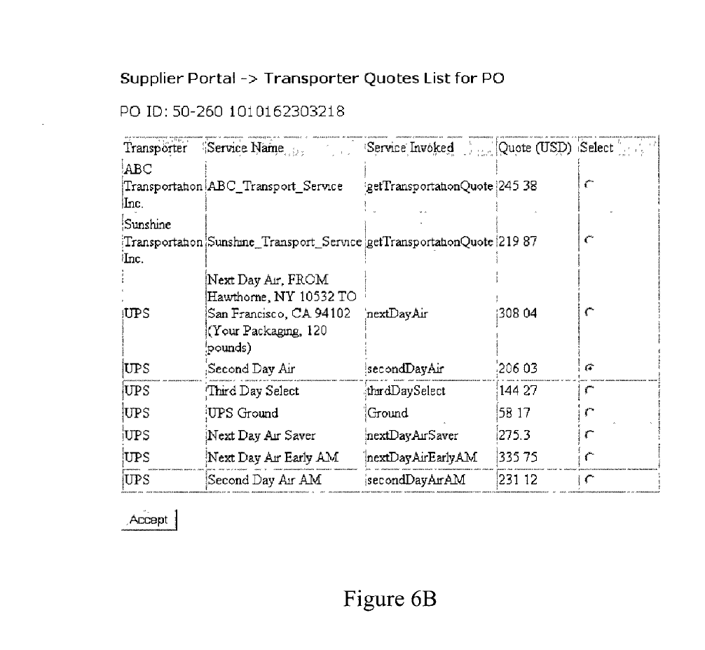

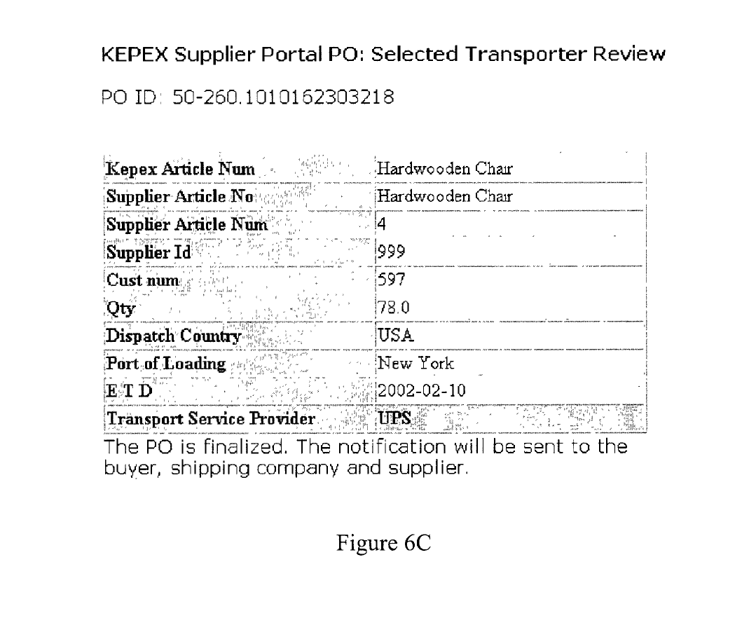

For example, a single user request for services at the user interface to the Common Alliance Interface 201 may be split by the Business Process Layer into a plurality of requests, one for each of a plurality of shipping service providers, receivable at the service provider interface, Webservice Interface 214. The respective shipping service providers receive these requests at the service provider interface through their respective Adaptation Layer 222. This layer performs the data mapping and data conversion required to produce an organized response to a service invoker. The first step in that organized response is to transmit the request to the Legacy Application 221. Following processing by the Legacy Application 221, any response is received by the respective Adaptation Layer 222. If necessary, multiple responses by a particular Legacy Application 221 to a request are aggregated by the respective Adaptation Layer 222 and presented at the service provider interface. On the other side of the service provider interface, transparent to the shipping service providers, the responses of the different shipping service providers are aggregated by the Business Process Layer and returned to the requesting user at the user interface (as shown in FIG. 6B). It is in this manner that the Common Alliance Interface 201 is able to talk to the Legacy Applications 221.

It is to be noted that the invention's implementation in the Business Process Layer allows the specification registry to be dynamically updated. That is, once a particular business process is incorporated into the Business Process Layer, new shipping service providers may publish their specifications for the business process in the specification registry and existing shipping service providers may republish changed specifications without requiring a change in the Business Process Layer. Consequently, updates to the specification registry may be made in real time. It is important to emphasize that this capability is not available to prior art approaches described in FIGS. 1B and 1C, which have no equivalent to a specification registry and must revise their applications in response to changes in the way shipping service providers require their services to be invoked.

In the preferred embodiment of the invention, where the Business Process Layer 215 is implemented using Web Services and the specification registry is a UDDI Registry 210, the method signatures described above for handling service requests and responses thereto may, as an implementation, use XML as an input and have an XML string as their result. As a multi-carrier connector, the Common Alliance Interface 201 makes the overall shipping processes simpler than current practices for several reasons. First, a set of common interfaces (e.g. corresponding to RFQ, shipping and tracking) are available to all the shipping service providers via the Service Template. This eases the work of a service requester (i.e. a user/customer requesting services from a shipping service provider) who can now issue a single service request using standardized interfaces as opposed to composing and sending several complex requests to multiple targeted service providers.

Second, the Common Alliance Interface 201 also eases the job of the user/customer application developers who are thereby able simply to code once for all the Shipping Service Providers. Third, the Common Alliance Interface 201 reduces development effort by providing a reusable interface, thereby allowing easier adaptation to new service requirements or technologies. The common interface is implemented by all the shipping service providers and the resulting Web Services 211 are published in the UDDI Registry 210 so that trading partners and customers can search and retrieve those services.

The Adaptation Layer 222 is the key connector between the Web Services 211 (which are implemented in the Business Process Layer) and the Legacy Applications 221 of an industry. The Adaptation Layer 222 works as a service dispatch and aggregation broker—it is responsible for manipulating the request from the user and the response from the server. When a user/customer invokes a Web Service 211 by a request presented at the Common Alliance Interface 201, the request will be split into as many copies as required by the number of service providers listed in the UDDI Registry 210 for the requested service. Then each of the split requests is sent via the service provider interface, Webservice Interface 214, to the Adaptation Layer 222 that then does the method signature mapping between the service provider's Legacy Application 221 and Web Services methods 211. The Adaptation Layer 222 also performs protocol transformation (e.g. from SOAP to HTTPS), and dispatches the request to the appropriate shipping service provider server hosting the Legacy Application 221.

The Dynamic Data Binding mechanism is executed at the Adaptation Layer 222. This mechanism simply binds the dynamic data (i.e. the live and updated data from the Shipping Service Provider's server 110) to the response XML. The Web Services 211 of each Shipping Service Provider implement the methods that are defined in the Business Process Layer, in conformance with entries made by the Shipping Service Provider in the UDDI Registry 210. The Web Services 211 are implemented by each Shipping Service Provider in their respective Adaptation Layer 222. The user/customer finds the desired e-Logistics service from those which the Common Alliance Interface 201 makes available to the user/customer with the assistance of UDDI Registry 210. However, the UDDI Registry—as well as the Business Process Layer—are transparent to the user. The user/customer simply requests the desired e-Logistics service. The Common Alliance Interface 201 then splits this user request so that separate requests are created for each SSP with an entry for the requested service in the UDDI Registry 210. The Business Process Layer then generates appropriate method signatures for each of the split requests and sends an XML string corresponding to each method signature to the respective Adaptation Layer 222, via the Webservice Interface 214, to invoke the requested service. The request is then sent to the appropriate Shipping Service Provider (SSP) Legacy Application 221 (which corresponds to server 110). A response is sent back by the Legacy Application 221, aggregated if necessary for a particular SSP and converted to an appropriate XML string (using the Web Services Definition Language) by the Adaptation Layer 222, and sent to the Business Process Layer via the Webservice Interface 214. Requests from multiple SSPs are then aggregated at the Common Alliance Interface 201 for presentation to the user/customer.

For example, for the RFQ business process implemented as a Web Service, the Business Process Layer 215 could contain a method such as:

public String getServicesQuotes (String xmlInput)

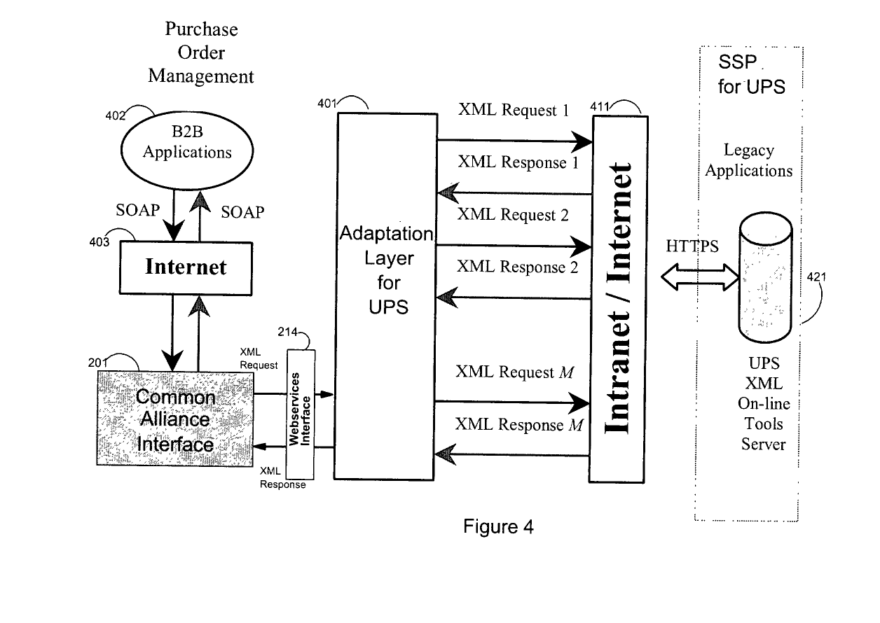

This method could be implemented by each of the Shipping Service Providers in their respective Adaptation Layer 222. This method would then be called for each of the SSPs by the respective split service request, as described above, to obtain quotes from different service providers. This method takes an XML String as an input and returns an XML String as an output, as shown in greater detail and discussed below with in connection with FIG. 4. A concrete example of how a Request XML and an aggregation of Response XMLs are seen by the requesting user is given in connection with the discussion of FIG. 6B, below.

ELPIF serves as a service model using a design pattern in which all Web Services 211 (i.e. Web Service implementation by the particular SSPs of specified e-Logistics services) are built on the Common Alliance Interface 201. As described above, the method signatures of these Web Services are provided by the Business Process Layer 215, based on the UDDI Registry. Shipping Service Providers can add or change entries in the UDDI Registry, without any change being required in the Business Process Layer 215. When a Web Service is requested by a user/customer, the Common Alliance Interface 201 will split that request into a plurality of requests, one for each SSP having a corresponding entry in the UDDI Registry. The method signature corresponding to the requested service is in the Business Process Layer 215, which then uses the UDDI Registry entries to create separate instances of the method-signature for each of the split requests. Instantiation will produce an XML Request string, which will be sent to the respective SSP's Adaptation Layer 222 via the Webservice Interface 214. Ultimately, these requests will be returned as XML Response strings by the Adaptation Layer 222. Thus the user/customer need only invoke a desired Web Service once. The complexity of the interactions among the Business Process Layer 215, the Adaptation Layer 222 and the Legacy Applications 221 are transparent to the user/customer who requests the service or to the developer of the user/customer's application (e.g. Business Process Manager 100).

In the prior art customers were able to satisfy their shipping needs by selecting a particular shipping service provider and relying upon that service provider's interface for shipping and tracking. For a customer to have a choice of service providers, the customer either would have to develop its own interfaces to the systems of the various service providers (as shown in FIG. 1B) or purchase and use an application developed by a third party to provide these interfaces (as shown in FIG. 1C). Each of these prior art solutions fails to provide a common interface usable by all. The solution in FIG. 1B developed by a particular user does not serve other users. The solution provided by a third party in FIG. 1C presumably relies upon an intermediary database for storing necessary information from the various service providers. There is no dynamic binding of SSP data, and there is no mechanism (comparable to a specification registry) for dynamic addition of new providers and services. The conventional alternative for providing a common interface usable by all is an agreed upon standard, requiring both service providers and user applications to write to the common standard, but this alternative does not currently exist in the e-Logistics industry.

In the absence of standardization of the interfaces, the customer or a third party would have to develop a shipping application by incorporating adaptations to a plurality of shipping service provider interfaces, exercising interfaces invocations in real-time employing late binding, and aggregating responses from this plurality into a single unified response.

The ELPIF framework of the present invention provides an alternative methodology for achieving the benefits of standardization. It does so by using the UDDI Registry to integrate the business processes of e-Logistics 112 (the RFQ process 101, the shipping process 103, and the tracking process 105) into an interface (the Common Alliance Interface 201) usable by the user/customer, and providing Service Templates usable by the shipping service providers. This integration includes dynamic binding of live data in the legacy applications of the shipping service providers, thereby avoiding the intermediary database created by third parties in prior art solution shown in FIG. 1C.

The user/customer is represented in FIG. 1A by a Business Process Manager 100, which according to the invention uses the Common Alliance Interface 201 to invoke the various business processes 101, 103 and 105 and obtains PO updates 102, 104 and 106. Each SSP provides (and maintains) entries in the UDDI registry 210, and can use the Service Template of the invention as a prototype of the Adaptation Layer 222.

Whereas a conventional “standard” consists of a specification for an interface, to which all participants then conform, the present invention incorporates within an interface sandwich (e.g. within the Business Process Layer 215 sandwiched between the Webservice Interface 214 and the Common Alliance Interface 201) the business processes which characterize the electronic marketplace. This is accomplished, in the preferred Web Services implementation of the invention, through the UDDI Registry 210 which is the dynamic repository for service provider specifications as to how their web services are to operate. Instead of having a single interface “standard” the invention provides a dual interface, having a Common Alliance Interface 201 for the customer side of the transaction and a Webservice Interface 214 for the supplier side of the transaction, with the relevant business processes being sandwiched between. This novel approach is made feasible on the Internet by the availability of Web Services.

ELPIF requires each Shipping Service Provider to support at least three basic e-Logistics processes: (1) RFQ Web Services (2) Shipping Web Services, and (3) Tracking Web Services. These processes are incorporated into the Web Services layer 211 by means of appropriate entries in a registry accessible to the Common Alliance Interface 201 and specifying how each of the processes operates. The interface for these services are defined at the Common Alliance Interface 201. The services themselves are implemented by the service provider within the Adaptation Layer 222. In the preferred Web Services embodiment of the invention, each SSP supports these processes as Web Services 211 by maintaining appropriate entries in the,UDDI registry 210 and by implementing the processes in an Adaptation Layer 222. The Adaptation Layer 222 is also used by the service provider to map its Legacy Application 221 in accordance with the interface defined at the Business Process Layer 201. In the preferred embodiment, this implementation can be accomplished by modifying a Service Template provided by the invention. The Service Template is an advantageous simplification of the work required of the service provider.

These three Web Services 211 are briefly described as follows.

1. RFQ Web Services

Any B2B application can send a request to the RFQ Web Services. The RFQ Web Services then dynamically bind the data entered by the requester (such as shipping destination, weight) to the input XML template and sends the request to the Adaptation Layer 222. The Adaptation Layer 222 dispatches the request to the appropriate backend server 110 and receives a response from the backend server 110. If the request generates a plurality of responses, these responses are combined by the Adaptation Layer 222. The Adaptation Layer 222 then binds the live date received from the backend server 110 with the response XML template and sends it via the Webservice Interface 214 and through the Business Process Layer 215 to the Common Alliance Interface 201 where it is combined with responses from other service providers and then sent back to the B2B application. The authentication of the user will be verified at each step by examining the userid and password that are associated with the application. This RFQ process is actually used by the Service Requester to compare the different available services so she can select the most favorable one.

2. Shipping Web Services

After the user selects the transportation service provider, the next process is sending a shipping request to the shipping Web Services. The Shipping Web Services 211 provided by the Service Provider then dynamically bind the data entered by the Service Requestor 205 (such as shipping destination, weight) to the input XML template and sends the request to the Adaptation Layer 222. The Adaptation layer 222 then sends the request to the appropriate backend server (110 in FIG. 1 and 221 in FIG. 2) and receives a response from the backend server 221. The Adaptation Layer 222 then binds dynamically the live data received from the backend server 221 with the response XML template and sends it back to the B2B application via the Common Alliance Interface 201. The user/customer will be given a tracking number embedded in the response. Once the goods are shipped, the tracking number is mapped to the purchase order ID in a B2B application. Similarly, authentication of the service requester application is performed by verifying her user id and password.

3. Tracking Web Services

The supplier, buyer or any parties in the supply chain may want to check the status of the shipment corresponding to a specific purchase order. After the customer's e-commerce server 100 gets the shipping status from the Tracking Web Services 105, it will update 106 the manifest information in the purchase order database. The Tracking Web Services 105 talks to the backend server 110 to retrieve the detailed shipping Status through adaptation layer 222 and hence can track the status of the shipment.

### E-LOGISTICS EXAMPLE: UPS INTEGRATION

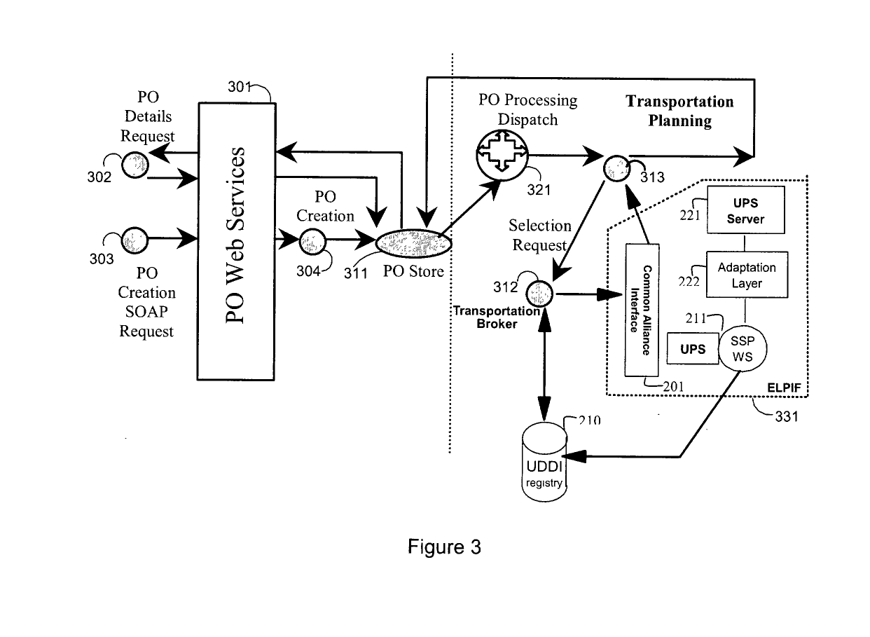

ELPIF encourages online enterprises to create new Web Services and helps them to leverage existing ones. ELPIF enables all the enterprises with various platforms to be integrated into a common platform, enabling all of them to interact with one another. ELPIF is particularly suitable for small and medium sized companies that often seek a quick and cost effective solution for business process integration. This can be seen with reference to FIG. 3, which shows how ELPIF 331 (showing details as in FIG. 2) is used by an exemplar business application for the creation and details checking of a purchase order. Once a purchase order is created (304, following request 303 responded to via PO Web Services 301) and then stored 311 (with details being provided upon request 302) it must go through various business process steps to final completion.

One issue that the Business Process Manager 100 needs to address is transportation planning. This is a vital issue as it is concerned with many factors such as lowest shipping cost, easy availability, and so on. Transportation Broker 312 is an intelligent agent within the Business Process Manager 100 that dynamically creates a response list from the available service providers such as UPS and FedEx who meet the criteria of the requester most efficiently. All shipping service providers should have their own Web Services published in the UDDI Registry 210. The selection request made by the customer is sent to the Transportation Broker 312 via PO Processing Dispatch module 321 and Transportation Planning module 313. Transportation Broker 312 then finds the appropriate service from the UDDI Registry 210 and binds the result back to the Service Requester 205. The transportation Web Services may include ABC Transportation Web Services, UPS Web Services, and so on.

FIG. 4 depicts the integration architecture of a shipping service provider. UPS is taken as an example of a Shipping Service Provider. UPS Web Services such as RFQ, Shipping, and Tracking are explained in this disclosure though there can be many more services such as Warehouse Management, Transportation Management and so on. The Adaptation Layer 401 which supports these Web Services invokes them with the UPS XML Online Tools Server which is part of UPS Legacy Application 421.

When a Web Service, such as RFQ Web Service for UPS (implemented in Adaptation Layer 401, corresponding to 222 in FIG. 2), is invoked from a customer B2B Application 402 by a SOAP call over the Internet 403 to Common Alliance Interface 201 and Business Process Layer 215 (not shown in FIG. 3) and via Webservices Interface 214, it binds data such as country of dispatch, source, and weight to the XML Request template. The Adaptation Layer 401 works as a service dispatch broker and service aggregation broker. Once the Adaptation Layer 401 receives an XML Request (which might be the aggregation of multiple requests responsive to a lookup for Next Day Air Service by UPS Standard service), it sends these requests to the UPS Server 421 over network 411. The responses received from UPS Server 421 are aggregated by the Adaptation Layer 401 which, after mapping the live data received to the response XML template, sends the response back to the requesting B2B application 402 via Webservice Interface 214, Common Alliance Interface 201 and through the Internet 403.

XML Request and Response Templates

To further convey the ideas of this invention, a description of sample XML Request and Response templates is provided.

A user/customer application requests a service at the Common Alliance Interface 201, which generates a corresponding XML request based on an XML Request Template. The XML Request Template can have structure as showed in List 1. An example of a generated XML Request is given in List 2, where two service providers are shown (based on entries in the UDDI Registry) as providing the requested service. Conditional upon the XML request generated, the Common Alliance Interface 201 may split the XML request to multiple service providers, forwarding the split requests to Business Process Layer 215 for preparation of appropriate method signatures. These method signatures are made particular to each respective service provider by Web Services 211, before being forwarded via Webservice Interface 214 to the corresponding service provider's Adaptation Layer 222.

List 1: Request XML Template

<?xml version=1.0>
<Access LicenseNum>123</AccessLicenseNum>
<UserId>pyadav</UserId>
<Password>2ppp4</Password>
<Shipment><SupplierName> spl</SupplierName><SourceAdd>
<City>CITY1</City>
<State>STATE1</State>
<postalCocle>ZTP1</PostalCode>
<CountryCode>COUNTRY1</CountryCode>
</SourceAdd>
<DestinationAdd>
<City>CITY2</City>
<State>STATE2</State>
<PostalCode>ZIP2</PostalCode>
<CountryCode>COUNTRY2</CountryCode>
</DestinationAdd>
<ServiceCode>SERVICEKEY</SerViCeCode>
<PackageWeight>WETGHT</PackageWeight>
</UnitOfMeasurement>lbs</UnitOfMeaSurement>
</Shipment>

List 2: An illustration of a request with sample data to two service providers.

<?xml version=1.0>
<Access LicenseNum>123</AccessLicenseNum>
<UserId>pyadav</UserId>
<Password>2ppp4</Password>
<Shipment>
<SupplierName> UPS</SupplierName>
<SupplierName> ABC</SupplierName>

<SourceAdd>
<City>Charlotte</City>
<State>NC</State>
<PostalCode>28213</PostalCode>
<CountryCode>US</CountryCode>

</SourceAdd>
<DestinationAdd>

<City>White Plains</City>
<State>NY</State>
<PostalCode>10603</PostalCode>
<CountryCode>US</CountryCode>

</DestinationAdd>
<ServiceCode>11</ServiceCode>
<ServiceCode>14</ServiceCode>
<Packageweight>100</PackaqeWeight>
</UnitOfMeasurement>lbs</UnitOfMeasurement>

</Shipment>

The request is dispatched to the appropriate service provider Adaptation Layer 222 by the Business Process Layer 215. The Adaptation Layer 222 manages the interaction with the Legacy Application 221 of the service provider, and composes the response received from the server back to the Service Requestor 205 via the Common Alliance Interface 201. The response is returned in an XML Response Template, an example of which is shown it List 3. If the request is an aggregation of multiple services offered by the service provider (for example, such as Quote for NextDayAir and Ground Service) the response from the service provider is aggregated by the Adaptation Layer 222. Service code number is mapped to the Service Name.

The Adaptation Layer 222 receives possibly multiple results from the service provider server (Legacy Application 221, and Back-end Server 110). It parses the results and replaces each token of the XML Response Template with the live data from the service provider. If there are multiple responses from the same service provider, the Adaptation Layer 222 integrates them into a single XML Response Template. An example of this is illustrated in List 4. The XML Response constructed by the Adaptation Layer 222 is then forwarded to the Business Process Layer 215 for processing to be subsequently returned to the Service Requestor 205.

List 3: XML Response Template

<?xml version=1.0>
<Response>
<Packageweight>WEIGHT</PackageWeight>
<UnitOfMeasurement>lbs</UnitOfMeasurement>
<RatedShipment serviceprovider=“sp1”>
<ServiceCode>SERVICEKEY</ServiceCode>
<Charges>
<CurrencyCode>USD</CurrencyCode>
<MonetaryValue>MONEY</MonetaryValue>
</Charges>
<DaysToDeliever>DELIVERYDAYS</DaysToDeliever>
<DelieveryTime>DELIVERYTIME</DelieveryTime>
</RatedShipment>
<RatedShipment serviceprovider=“sp2”>
<ServiceCode>SERVICEKEY2</ServiceCode>
<Charges>
<CurrencyCode>USD</Currencyeode>
<MonetaryValue>MONEY2</MonetaryValue>
</Charges>
<DaysToDeliever>DELIVERYDAYS2</DaysToDeliever>
<DelieveryTime>DELIVERYTIME2</DelieveryTime>
</RatedShipment>
</Response>

List 4: An illustration of a single service provider response, with sample data reflecting multiple services.

<?xml version=1.0>

<Response>

```
<PackageWeight>100</PackageWeight>
<UnitOfMeasurement>lbs</UnitOfMeasurement>
<RatedShipment serviceprovider=“UPS”>
  <ServiceCode>11</ServiceCode>
  <Charges>
    <CurrencyCode>USD</CurrencyCode>
    <MonetaryValue>300</MonetaryValue>
  </Charges>
    <DaysToDeliever>1</DaysToDeliever>
    <DelieveryTime>10:00AM</DeliveryTime>
</RatedShipment>
<RatedShipment serviceprovider=“UPS”>
  <ServiceCode>I4</ServiceCode>
  <Charges>
    <CurrencyCode>USD</CurrencyCode>
    <MonetaryValue>250</MonetaryValue>
  </Charges>
    <DaysToDeliever>2</DaysToDeliever>
    <DelieveryTime>11:00AM</DeliveryTime>
</RatedShipment>
```

</Response>

There may be XML responses from the Adaptation Layer 222 of one or more service providers. These are received via the Webservice Interface 214 at the Business Process Layer 215 and forwarded to the Common Alliance Interface 201, where responses from multiple service providers are aggregated for presentation to the Service Requestor 205. An example of an aggregated XML response that is returned to the Service Requestor 205 is illustrated in List 5.

List 5: An illustration with sample data of an aggregated response from multiple service providers.

<?xml version=1.0>

```
<Response>
    <PackageWeight>100</PackageWeight>
    <UnitofMeasurement>lbs</UnitOfMeasurement>
    <RatedShipment serviceprovider=“UPS”>
```

```
<ServiceCode>11</ServiceCode>
<Charges>
    <CurrencyCode>USD</CurrencyCode>
    <MonetaryValue>300</MonetaryValue>
</Charges>
    <DaysToDeliever>1</DaysToDeliever>
    <DelieveryTime>10:00AM</DeliveryTime>
```

```
    </RatedShipment>
    <RatedShipment serviceprovider=“UPS”>
```

```
<ServiceCode>I4</ServiceCode>
<Charges>
    <CurrencyCode>USD</CurrencyCode>
    <MonetaryValue>250</MonetaryValue>
</Charges>
    <DaysToDeliever>2</DaysToDeliever>
    <DelieveryTime>11:00AM</DeliveryTime>
```

```
    </RatedShipment>
    <RatedShipment serviceprovider=“ABC”>
```

<ServiceCode>01</ServiceCode>
<Charges>
<CurrencyCode>USD</CurrencyCode>
<MonetaryValue>220</MonetaryValue>
</Charges>
<DaysToDeliever>2</DaysToDeliever>
<DelieveryTime>10:00AM</DeliveryTime>

</RatedShipment>
</Response>

A Working B2B System Using ELPIF

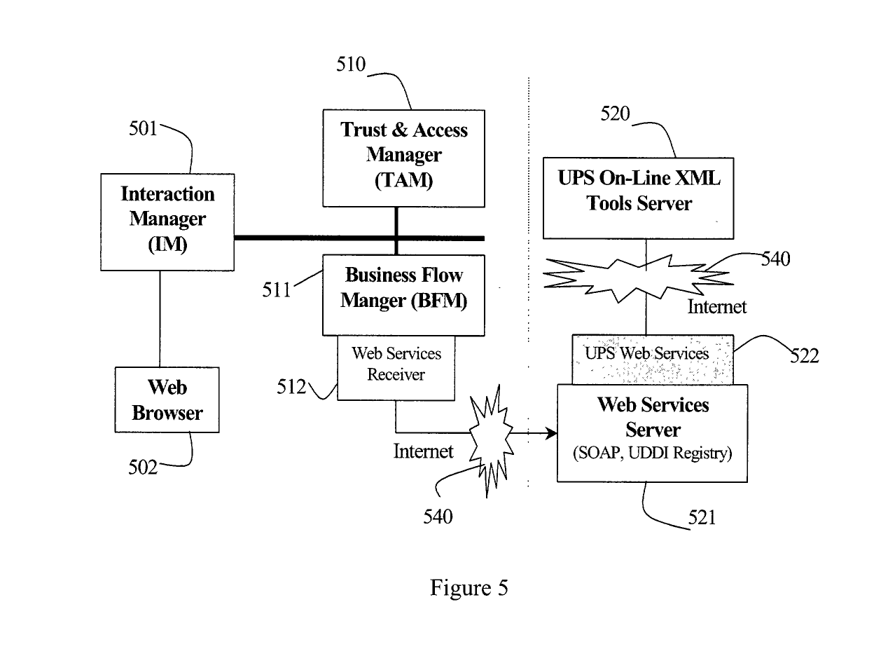

The B2B system is shown on the left side of FIG. 5. The detailed description can be found in “An e-business Integration & Collaboration Platform for B2B e-Commerce,” by Kumar Bhaskaran, Jen-Yao Chung, Terry Heath, Santhosh Kumaran, Raja Das and Prabir Nandi, in IEEE Conference WECWIS 2001 Third International Workshop of Advanced Issues of E-Commerce and Web-Based Information System, Jun. 21-22, 2001.

The Interaction Manager 501 (IM) houses solution parts responsible for driving the user/customer interaction. This is a model-view-controller framework consisting of a set of Java Beans, JSP (Java Server Pages) templates, and Servlets. The Trust and Access Manager 510 (TAM) houses the Organization Model. These form the basis for user/customer authorization, which is the process of determining whether an authenticated user/customer gaining access from Web Browser 502 has the right to perform an operation on a specific resource in a secure domain. The Business Flow Manager 511 (BFM) externalizes the flow definitions (control flows and data flows) and the business rules that drive the process choreography.

Besides the above-mentioned B2B platform, there is a Web Services Server 521 including a SOAP server and a private UDDI registry. As an example, UPS Web Services 522 is deployed and registered on it. The UPS Web Services 522 are supported over the Internet 540 by an On-Line XML Tools Server 520. A request from the Web browser 502 will be sent to the TAM 510 first to finish the single-sign-on (SSO) process. Then the subsequent pages will automatically attach the user credential information to the BFM 511. The BFM 511 will invoke a command through a Web Services Receiver 512 over the Internet 540 to a Web Services Server 521 to search UDDI server or invoke a Web Service based on the business context.

FIGS. 6A, 6B and 6C show the effect of the invention upon Purchase Order (PO) information as the PO is processed through the E-Logistics system. For the purposes of illustration, the user/customer is “Sears,” as shown in FIG. 6A. FIG. 6A illustrates the screen of the details of a specific PO. This information is derived from the purchase order database. The Dispatch Country is USA, and the port of loading is New York. Based on this information, the transportation broker 312 will search the UDDI registry 210 to get a transporter list of service providers in the United States. For each service provider, there may be multiple service offerings responsive to the PO. For each service, the user can invoke the PO Web Services 301 to get the quotes for this service, for example.

FIG. 6B illustrates the aggregated responses from three service providers: ABC Transportation Inc, Sunshine Transportation Inc and UPS. Note that there are multiple responses from service provider UPS, which were aggregated by the UPS Adaptation Layer 401. The responses from the three service providers were aggregated by the Common Alliance Interface 201. After the user reviews the quotes, he/she can select one as a transportation service provider for this specific purchase order. In FIG. 6B the selected Service Name is “UPS Next Day Air” as shown by the indicated radio button in the “Select” column. Upon hitting the “Accept” button the purchase order information will be updated. The updated purchase order information is shown in FIG. 6C. Note that the “Transport Service” column which was blank in FIG. 6A is marked “UPS” in FIG. 6C. At the same time, the notification will be sent to the buyer, supplier and shipping company

Though the focus of the foregoing discussion is on the shipping industry, the principles embodied in ELPIF can be applied to other domains. While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. An asymmetric electronic commerce interface, comprising:
a first interface being a Common Alliance Interface for users of specified electronic commerce services;
a second interface for providers of said specified electronic commerce services; and
a business process layer integrating one or more components of said specified electronic commerce services, said business process layer being sandwiched between said first and second interfaces and being transparent to said users,
wherein each of said service providers maintains access to said users by updating entries for said service provider in a registry of said specified electronic services and by providing an adaptation layer between a legacy application of said service provider and said business process layer, said registry being dynamic and being used in said business process layer integration.

2. An asymmetric interface as in claim 1, wherein said second interface is provided with a service template adaptable by each said service provider to provide said adaptation layer.

3. An asymmetric interface as in claim 2, wherein said specified electronic services are e-Logistics services.

4. An asymmetric interface as in claim 3, wherein said integrated components comprise an RFQ process, a shipping process and a tracking process.

5. An asymmetric interface as in claim 1, wherein said first interface and said business process layer are implemented using Web Services and said dynamic registry is a UDDI registry.

6. An asymmetric interface as in claim 5, wherein said adaptation layer is implemented using Web Services.

7. An asymmetric interface as in claim 1, wherein said adaptation layer provides dynamic binding of data from said legacy application to said business process layer.

8. An asymmetric interface as in claim 7, wherein said adaptation layer maps message signatures and performs protocol message transformations for service requests and service responses to said requests between said legacy application and said Business Process Layer.

9. An asymmetric interface as in claim 8, wherein a user request for services presented at said first interface is split for sending via said second interface to each of a plurality of said service providers, and wherein service responses from each of said plurality of service providers to said split user request are aggregated for return to said user at said first interface.

10. An asymmetric interface as in claim 9, wherein an Extensible Markup Language (XML) is used to provide a template for said service requests and said service responses.

11. A method for providing specified electronic commerce services from incompatible service provider systems to users, comprising the steps of:
developing a first interface for users of said specified electronic commerce services, said first interface being a common alliance interface;
developing a second interface for providers of said specified electronic commerce services;
integrating one or more components of said specified electronic commerce services into a business process layer, said layer being sandwiched between said first interface and said second interface and being transparent to said users,
wherein each of said service providers maintains access to said users by updating entries for said service provider in a registry of said specified electronic services and by providing an adaptation layer between a legacy application of said service provider and said business process layer, said registry being dynamic and being used in said business process layer integration.

12. A method as in claim 11, wherein said second interface is provided with a service template adaptable by each said service provider to provide said adaptation layer.

13. A method as in claim 12, wherein said specified electronic services are e-Logistics services.

14. A method as in claim 13, wherein said integrated components comprise an RFQ process, a shipping process and a tracking process.

15. A method as in claim 11, wherein said first interface and said business process layer are implemented using Web Services and said dynamic registry is a UDDI registry.

16. A method as in claim 15, wherein said adaptation layer is implemented using Web Services.

17. A method as in claim 11, wherein said adaptation layer provides dynamic binding of data from said legacy application to said business process layer.

18. A method as in claim 17, wherein said adaptation layer maps message signatures and performs protocol message transformations for service requests and service responses between said legacy application and said business process layer.

19. A method as in claim 18, wherein a user request for services presented at said first interface is split for sending to each of a plurality of said service providers via said second interface, and wherein service responses from each of said plurality of service providers to said split user request are aggregated for return to said user at said first interface.

20. A method as in claim 19, wherein an Extensible Markup Language (XML) is used to provide a template for said service requests and service responses.
